(19) United States
(12) Patent Application Publication
(10) Pub. No.: US 2009/0222499 A1
(43) Pub. Date: Sep. 3, 2009

(54) METHOD, APPARATUS AND STORAGE DEVICE FOR DATA PROTECTION

(75) Inventors: Zujing TAN, Shenzhen (CN); Guobin ZHANG, Shenzhen (CN); Weihua GENG, Shenzhen (CN); Peng ZHANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/394,704

(22) Filed: Feb. 27, 2009

(30) Foreign Application Priority Data
Feb. 28, 2008 (CN) 200810009379.7

(51) Int. Cl. G06F 17/30

(52) U.S. Cl. 707/204; 707/E17.009

(57) ABSTRACT

A method for data protection is disclosed. The method includes: setting a Logical Unit Number (LUN) key area; obtaining data change amount when data in the preset LUN key area change; determining whether the data change amount exceeds a preset threshold, and a snapshot is created if the data change amount exceeds the preset threshold. The disclosure further discloses an apparatus for data protection and a storage device including the apparatus for data protection. In embodiments of the disclosure, certain parts in the LUN are set to be LUN key area, and a quantitative strategy is initiated, i.e., a snapshot is created only when the data change amount of the LUN key area exceeds a preset threshold. Snapshots are not created when the data in the key has no change or little change, in order to avoid waste of resources.

### CROSS-REFERENCE TO RELATED APPLICATIONS

This application claims priority to Chinese Patent Application No. 200810009379.7, filed Feb. 28, 2008, which is hereby incorporated by reference in its entirety.

### FIELD OF THE INVENTION

The disclosure relates to the field of data protection technology, and more particularly, to a method, apparatus and storage device for data protection.

### BACKGROUND

With the development of various services, the amount of data in storage systems increases at an unprecedented speed. Progresses of services also impose higher requirements upon data processing technologies with respect to availability, reliability, expandability, etc., in which data security is particularly important.

The major technologies used for data protection include making backups and snapshots of the data.

The definition of snapshot according to the Storage Network Industry Association (SNIA) is a completely usable copy of a data object, which includes an image of the data object at a time instant.

In other words, the data in a magnetic disk subsystem of which a backup should be created are scanned by software, and a Logic Unit Number (LUN) of a snapshot and a cache of the snapshot are established for the data of which a backup should be created. During the fast scanning, the data blocks which will be modified soon in the process of creating a backup are also copied quickly to a snapshot cache. The snapshot LUN is a group of pointers pointing to the invariable data blocks (during the process of creating a backup) in the snapshot cache and the magnetic disk subsystem. While normal services are in progress, a complete backup of the original data is generated by the snapshot LUN.

There are currently three main snapshot technologies: virtual snapshots, split images, and copying as required.

Snapshot technologies may obtain the original LUN data in a shorter time, occupy less storage space, and rely on relatively mature technologies for real-time protection. There are three ways in which snapshot technologies are currently used: The first one is manual operations by users; the second one is using the snapshot technologies in conjunction with other services (such as LUN copying and remote images); the third one is using snapshots periodically. In the strategy of creating snapshots automatically, snapshots are created only periodically, that is, creating snapshots at predetermined time instances and, generating current instant snapshots for specified time instants.

In implementing and developing various snapshot technologies, the inventor discovered that existing methods for periodically creating snapshots have a number of problems. Specifically, the strategies used in existing methods are often too simply and, therefore, have major limitations in data protection. For example, when no change or little change is made to the data in a predetermined time period, snapshots may still be created as configured by the system, and, therefore, system resources are wasted.

### SUMMARY

The embodiments of the invention are described as follows.

According to one embodiment, a method for data protection includes (1) obtaining data change amount when data in a preset Logical Unit Number (LUN) key area is changed; and (2) determining whether the data change amount exceeds a preset threshold, and creating a snapshot if the data change amount exceeds the preset threshold.

According to another embodiment, an apparatus for data protection includes (1) a first processing unit, configured to obtain data change amount when data in a preset Logical Unit Number (LUN) key area is changed; (2) a determination unit, configured to determine whether the data change amount exceeds a preset threshold and send a determination result; and (3) a second processing unit, configured to send information instructing to create a snapshot when the determination result indicates that the data change amount exceeds the preset threshold.

According to still another embodiment, a storage device may include the apparatus for data protection.

Alternatively, a computer-readable medium includes computer usable instructions for instructing a digital processor to provide data protection.

### BRIEF DESCRIPTION OF THE DRAWINGS

FIG. 1 is a flowchart illustrating the method for data protection according to one embodiment;

FIG. 2 is a flowchart of a method for data protection according to one embodiment;

FIG. 3 is a flowchart of another method for data protection according to another embodiment;

FIG. 4 is a block diagram of a data protection apparatus according to one embodiment;

FIG. 5 is a block diagram of a data protection apparatus according to another embodiment;

FIG. 6 is a block diagram of a storage device according to one embodiment;

FIG. 7 is a block diagram of a data protection apparatus in a storage device according to one embodiment; and

FIG. 8 is a block diagram of a data protection apparatus in a storage device according to another embodiment.

### DETAILED DESCRIPTION

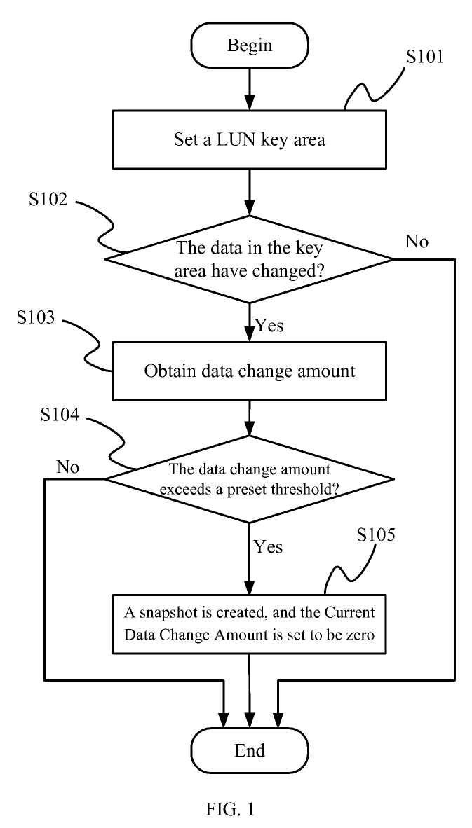

FIG. 1 illustrates an embodiment of a method for data protection. Specifically, it includes the following process:

Block S101: A LUN key area is set. The setting of the LUN key area may be performed by referring to the Logical Block Addressing (LBA) range. For example, a space in one or more fields of LBA range in LUN is set to be the key area. Or the LUN may be divided into subareas, such as A, B, C, D, E . . . . One or more of the subareas such as A, B subareas are set to be key areas. The specific setting may be performed by users according to requirements.

Block S102: It is monitored whether the data in the key area are changed. If the data are changed, the procedure proceeds to step S103; otherwise, the procedure ends. The monitoring operation may be performed periodically.

Block S103: Data change amount is obtained.

Block S104: It is determined whether the data change amount exceeds a preset threshold. If the data change amount exceeds a preset threshold, the procedure proceeds to step S105; otherwise, the procedure ends.

Block S105: A snapshot is created, a Current Data Change Amount is set to zero, and the procedure ends. The Current Data Change Amount is configured to indicate accumulated data change amount before the change operation. The Current Data Change Amount may be stored at a preset address.

In addition, the data change amount obtained in step S103 may be an accumulated data change amount, i.e., the sum of the data change amount when the write operation is performed to the preset LUN key area and the Current Data Change Amount before the write operation. The data change amount obtained in step S103 may also be the data change amount when the write operation is performed to the preset LUN key area.

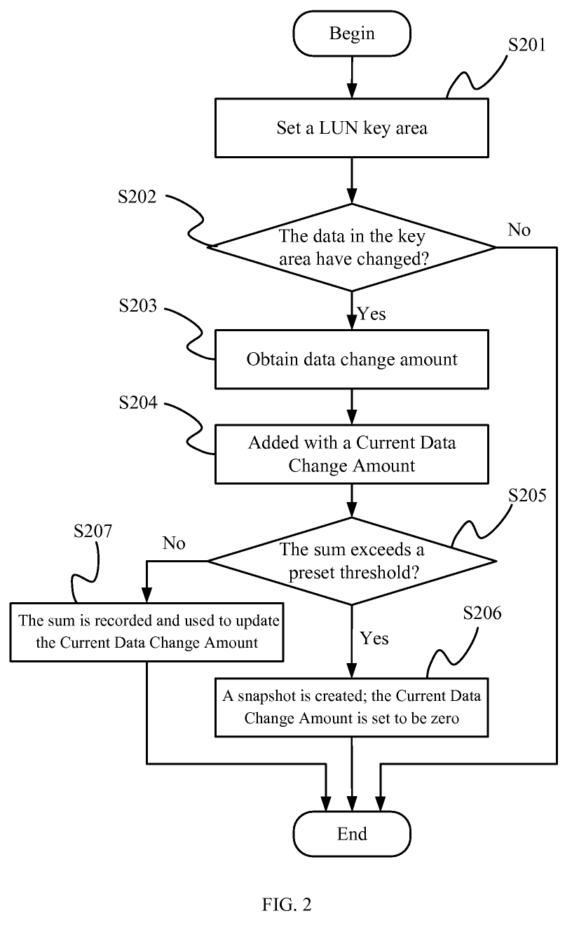

FIG. 2 illustrates another embodiment of a method for data protection. Specifically, blocks S201 to S203 are substantially similar to blocks S101 to S103 as depicted in FIG. 1. The data change amount obtained in block S203 is caused by the write operation performed by a user to the key area. Operations by the user, such as adding, deleting or updating, on the data in the key area may cause data change. Thus, when the user performs an operation, it may be determined whether the operation is a write operation to the key area. If a write operation is implemented is in the key area, it may be determined that the amount of data written is the data change amount.

Block S204: A sum is obtained by adding the data change amount with the Current Data Change Amount. The Current Data Change Amount may be stored at a preset address.

Block S205: It is determined whether the sum exceeds a preset threshold. If it exceeds the preset threshold, the procedure proceeds to block S206; otherwise, the procedure proceeds to block S207. The preset threshold may be set according to the specific requirement of the user, and may be adjusted at any moment.

Block S206: A snapshot is created; the Current Data Change Amount is set to zero. The procedure ends.

Block S207: The sum is recorded and is used to update the Current Data Change Amount. The procedure ends. The Current Data Change Amount is updated with the sum. The Current Data Change Amount after being updated equals to the sum.

Unlike the existing methods for creating snapshots at predetermined time instants, the embodiments adopt a quantitative strategy, that is, data in the LUN key area are monitored and a snapshot is created automatically when the data change amount in the key area exceeds the preset threshold. During the period when no operation is performed, or the operations only involve data outside the key area, or, the data in the key area has no change or few changes, snapshots are not created. Therefore, the total number of snapshots generated for data protection is reduced, the resource consumption is reduced, and the system efficiency is increased. Furthermore, the generated snapshots are highly pertinent to the key area since the methods only respond to the changes made in the key area. Therefore, the resource usage becomes more efficient. In addition, the determination logics become clearer and more concise.

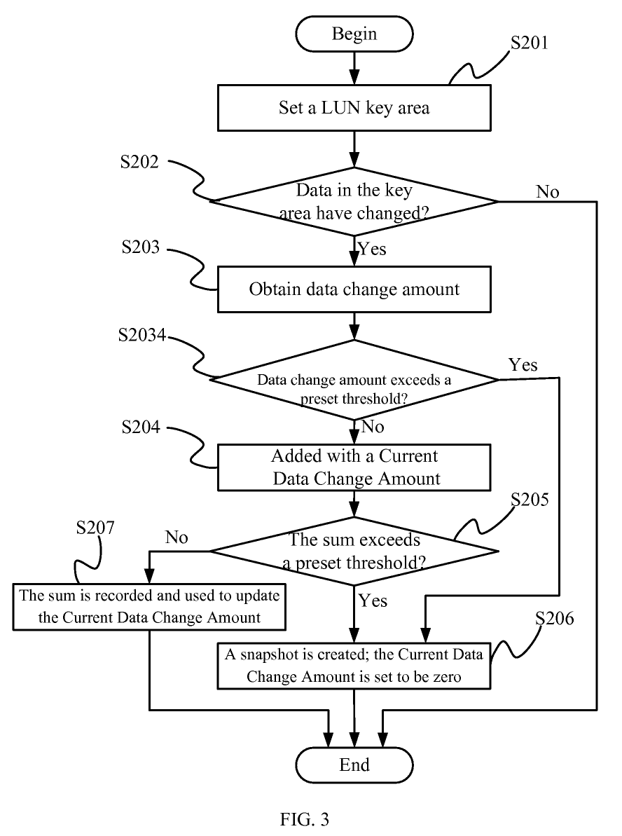

FIG. 3 illustrates another embodiment of a method for data protection. Specifically, when the data in the key area changes significantly as a user makes a certain operation, the data change amount associated with the operation exceeds the preset threshold without being added with the Current Data Change Amount. In this case, the operation of adding it to the Current Data Change Amount is not necessary and, instead, a snapshot is created instantly. Therefore, according to this embodiment, the procedure may proceed to block S2034 after the data change amount of the key area is obtained.

Block S2034: It is determined whether the data change amount exceeds the preset threshold. If the data change amount exceeds the preset threshold, the procedure proceeds to block S206; otherwise, the procedure proceeds to block S204.

It should be noted that in all the embodiments described above, the LUN key area may be preset. In other words, the LUN is divided into a key LUN and a non-key LUN according to the requirement of a user. The data change amount of the key LUN instead of the entire LUN is monitored.

It would be appreciated by one skilled in the art that all or part of the steps for implementing the methods described above may be implemented with hardware instructed by computer executable program instructions. The program instructions may be stored in a computer readable storage medium. The storage medium may be a Read Only Memory (ROM), a Random Access Memory (RAM), a magnetic disk, or a Compact Disk.

According to another embodiment of the invention as depicted in FIG. 4, a data protection apparatus is provided. The data protection apparatus includes a first processing unit 111, a determination unit 112, and a second processing unit 113.

The operations and functions of the data protection apparatus are described as follows.

The first processing unit 111 monitors the data in the preset LUN key area, obtains data change amount when the data in the LUN key area change. The LUN key area may be set by a user according to his (or her) requirement with reference to the LBA range. For example, the spaces in a field or some fields in the LBA range in the LUN may be set to be key areas. Alternatively, the LUN may be divided into subareas, such as A, B, C, D, E, etc. One or more subareas, such as subareas A and B, may be set to be key areas.

The data in the preset LUN key area may be monitored periodically by the first processing unit 111.

Operations by a user, such as adding, deleting or updating, on the data in the key area may cause a change of the data. Therefore, when the user performs an operation, it may be determined whether the operation is a write operation performed to the key area. If the operation is a write operation performed to the key area, there are two ways to determine the data change amount.

The first one is to obtain the data change amount caused by the write operation and add the data change amount to the Current Data Change Amount, and the result is set to be the data change amount.

Alternatively, when an operation by the user causes a significant change to the data in the key area, the data change amount associated with the operation exceeds the preset threshold without being added to the Current Data Change Amount. In such case, the data change amount may be the data change amount caused by the write operation performed to the preset LUN key area.

The determination unit 112 determines whether the data change amount exceeds a preset threshold and sends the determination result. The preset threshold may be set according to the specific requirement of a user, and may be adjusted at any moment.

The second processing unit 113 receives the determination result, and sends information instructing to create a snapshot when the determination result indicates that the data change amount exceeds the preset threshold. The second processing unit 114 further sets the Current Data Change Amount to zero. The Current Data Change Amount may be stored at a preset address. When it is determined by the determination unit 112 that the data change amount provided by the first processing unit 111 exceeds the preset threshold, the second processing unit 113 sets the Current Data Change Amount at the preset address to be zero.

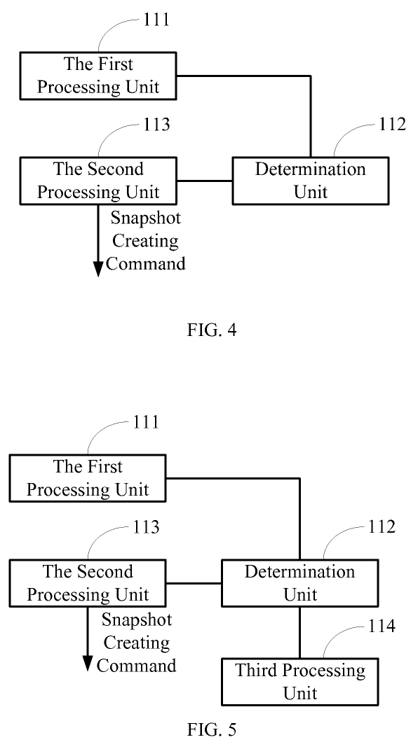

FIG. 5 shows a block diagram of a data protection apparatus.

Compared with the above embodiment, this embodiment may further include a third processing unit 114. Similarly, the third processing unit 114 receives the determination result of the determination unit 112. The third processing unit 114 then updates the Current Data Change Amount with the data change amount when the determination result indicates that the data change amount does not exceed the preset threshold. The updated Current Data Change Amount equals to the data change amount.

When it is determined by the determination unit 112 that the result provided by the first processing unit 113 does not exceed the preset threshold, the third processing unit 114 updates the Current Data Change Amount at the preset address with the data change amount.

It should be noted that in all the embodiments described above, the LUN key area may be preset. In other words, the LUN is divided into a key LUN and a non-key LUN according to the requirement of a user. The data change amount of the key LUN instead of the entire LUN is monitored by the first processing unit 111.

According to various embodiments of the invention, a quantitative strategy is adopted, that is, the data change amount is obtained by monitoring the data in the LUN key area utilizing the first processing unit 111. When the data change amount of the key area exceeds the preset threshold, information is sent by the second processing unit 113 for creating a snapshot.

During the period when the user performs no operation, or when the user performs operations on only the data outside the key area, that is, in the cases that the data in the key area has no change or few changes, no snapshot is created, or fewer snapshots are created, thereby resource consumption is reduced and system efficiency is increased.

Furthermore, snapshots created as such are highly pertinent to the key area since the system only responses to changes made to the data in the key area. Therefore, resource usage becomes more efficient. In addition, the determination logics become clearer and more concise.

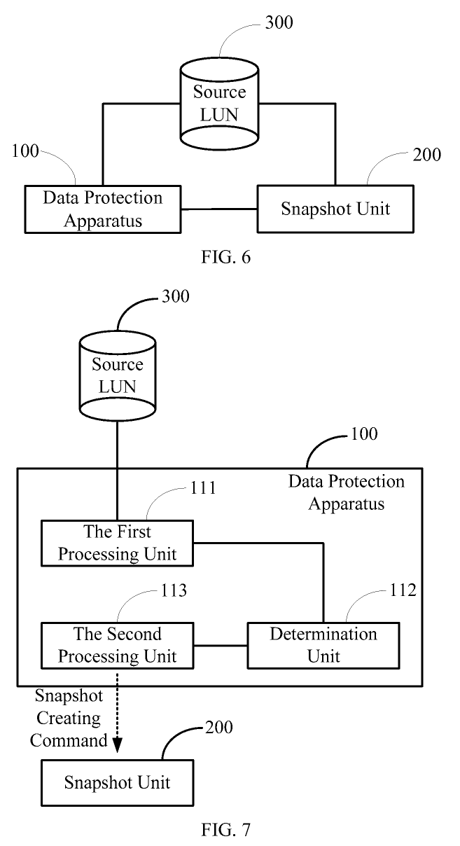

FIG. 6 shows a block diagram of a storage device according to still another embodiment. The storage device includes a data protection apparatus 100, a snapshot unit 200 and a source LUN 300.

The source LUN 300 provides an LUN for data storage and access space in basic service applications. The snapshot unit 200 is configured to create snapshots for the source LUN 300.

The operations and functions of the storage device are described as follows.

The data protection apparatus 100 monitors the data of the preset key area, obtains data change amount when a change of the data in the key area is detected. It is determined whether the data change amount exceeds the preset threshold. If the data change amount exceeds the preset threshold, information for creating a snapshot is sent to the snapshot unit 200. The Current Data Change Amount is further set to zero. Otherwise, the Current Data Change Amount is updated with the data change amount.

The Current Data Change Amount may be stored at a preset address. The preset threshold may be set according to the specific requirement of a user, and may be adjusted at any time instance. The snapshot unit 200 creates a snapshot for the source LUN when it receives the information for creating a snapshot.

An operation by the user, such as adding, deleting or updating, on the data in the key area may cause data change. When the user performs such an operation, it may be determined whether the operation is a write operation to the key area. If the operation is a write operation performed to the key area, two methods are utilized to determine the data change amount.

The first one is obtaining the data change amount caused by the write operation and adding the data change amount to the Current Data Change Amount. The result is determined to be the data change amount.

Another one is that when an operation of the user causes a significant change to the data in the key area, the data change amount itself may exceed the preset threshold without being added with the Current Data Change Amount before the operation In this case, the data change amount may be set to the data change amount caused by the write operation performed to the preset LUN key area.

FIG. 7 shows a block diagram of a data protection apparatus in a storage device according to still another embodiment. The data protection apparatus includes: a first processing unit 111, a determination unit 112, and a second processing unit 113.

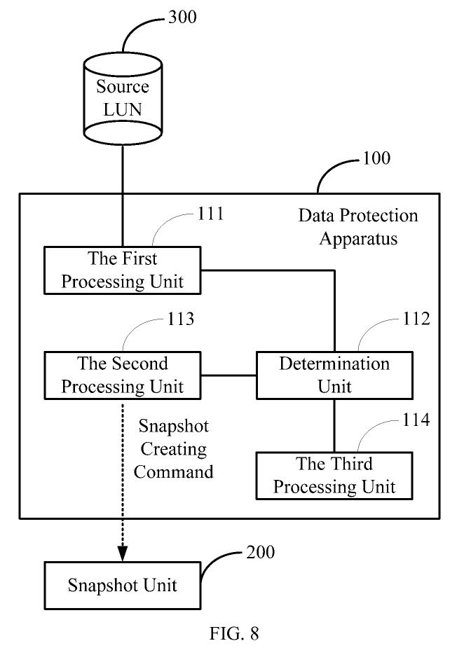

FIG. 8 shows a block diagram of a data protection apparatus in a storage device according to another embodiment. In this embodiment, a third processing unit 114 may further be included in the data protection apparatus. The third processing unit 114 receives the determination result of the determination unit 112, and updates the Current Data Change Amount with the data change amount when the determination result indicates that the data change amount does not exceed the preset threshold. The updated Current Data Change Amount equals to the data change amount.

The operations and functions of the data protection apparatus are substantially similar to those described earlier in this application.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Any recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for data protection comprising:
obtaining a data change amount when data in a preset Logical Unit Number (LUN) key area are changed;
determining whether the data change amount exceeds a preset threshold; and
creating a snapshot if the data change amount exceeds the preset threshold.

2. The method for data protection according to claim 1, further comprising:
monitoring the LUN key area; and
obtaining the data change amount by computing an amount of data that is changed in the preset LUN key area.

3. The method for data protection according to claim 1, further comprising:
monitoring the LUN key area; and
obtaining the data change amount by adding a Current Data Change Amount to an amount of data that is changed in the preset LUN key area.

4. The method for data protection according to claim 1, further comprising setting a Current Data Change Amount to zero after creating the snapshot.

5. The method for data protection according to claim 1, further comprising:
updating a Current Data Change Amount to be the data change amount if the data change amount does not exceed the preset threshold.

6. The method for data protection according to claim 1, wherein the LUN key area is one of a preset Logical Block Addressing range and a preset LUN subarea.

7. An apparatus for data protection comprising:
a first processing unit, configured to obtain a data change amount when data in a preset Logical Unit Number (LUN) key area is changed;
a determination unit, configured to determine whether the data change amount exceeds a preset threshold and send a determination result; and
a second processing unit, configured to send information for creating a snapshot when the determination result indicates that the data change amount exceeds the preset threshold.

8. The apparatus for data protection according to claim 7, wherein the first processing unit is further configured to monitor the LUN key area, and obtain the data change amount by computing an amount of data that is changed in the preset LUN key area.

9. The apparatus for data protection according to claim 7, wherein the first processing unit is further configured to monitor the LUN key area, and obtain the data change amount by adding a Current Data Change Amount to an amount of data that is changed in the preset LUN key area.

10. The apparatus for data protection according to claim 7, further comprising:
a third processing unit, configured to update a Current Data Change Amount to be the data change amount when the determination result indicates that the data change amount does not exceed the preset threshold.

11. The apparatus for data protection according to claim 7, wherein the LUN key area is one of a preset Logical Block Addressing range and a preset LUN subarea.

12. A storage device comprising:
a data protection apparatus, configured to obtain a data change amount when data in a preset Logical Unit Number (LUN) key area is changed, determine whether the data change amount exceeds a preset threshold, and send information for creating a snapshot if the data change amount exceeds the preset threshold;
a source LUN, configured to provide an LUN for data storage and access space to basic service applications; and
a snapshot unit, configured to create the snapshot for the source LUN.

13. The storage device according to claim 12, wherein the data protection apparatus is further configured to monitor the LUN key area, and obtain the data change amount by computing an amount of data that is changed in the preset LUN key area.

14. The storage device according to claim 12, wherein the data protection apparatus is further configured to monitor the LUN key area, and obtain the data change amount by adding a Current Data Change Amount to the amount of data that is changed in the preset LUN key area.

15. The storage device according to claim 12, wherein the data protection apparatus is further configured to update a Current Data Change Amount with the data change amount when the determination result indicates that the data change amount does not exceed the preset threshold.

16. The storage device according to claim 12, wherein the LUN key area is one of a preset Logical Block Addressing range and a preset LUN subarea.

17. A computer-readable medium, having computer usable instructions stored thereon for execution by a processor to perform:
obtaining a data change amount when data in a preset Logical Unit Number (LUN) key area is changed;
determining whether the data change amount exceeds a preset threshold; and
creating a snapshot if the data change amount exceeds the preset threshold.
